(19) United States
(12) Patent Application Publication
(10) Pub. No.: US 2006/0044464 A1
(43) Pub. Date: Mar. 2, 2006

(54) Image pickup device

(76) Inventors: Shigeo Inoue, Kumagaya-shi (JP); Michiharu Kanai, Isesaki-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/212,685

(22) Filed: Aug. 29, 2005

(30) Foreign Application Priority Data
Aug. 30, 2004 (JP) 2004-250537

(51) Int. Cl. H04N 5/225

(52) U.S. Cl. 348/373

(57) ABSTRACT

An image pickup device has a first casing, a second casing constructed to be engaged slidably into the first casing, an image pickup unit arranged in the first casing or the second casing, the image pickup unit receiving reflected light from an object via a lens and outputting image information corresponding to the reflected light, a cushioning member constructed to be connected to the first casing and the second casing, respectively, and is expanded or contracted according to sliding action of the second casing, and a recording unit connected to the first casing and the second casing via the cushioning member, the recording unit recording the image information output from the image pickup unit to a storage area, wherein the recording unit is held in empty space constructed to be made when the second casing is slid.

### CROSS-REFERENCE TO RELATED APPLICATIONS

This application is based upon and claims the benefit of priority from prior Japanese Patent Application No. 2004-250537, filed Aug. 30, 2004, the entire contents of which are incorporated herein by reference.

### BACKGROUND OF THE INVENTION

1. Field of the Invention

The present invention relates to an image pickup device, and more specifically, to an image pickup device having a cushioning structure for a storage device such as a hard disk.

2. Description of the Related Art

In recent years, in the field of image pickup devices, digital still cameras and the like as digital devices using CCD elements have spread rapidly in the place of conventional film photosensitive type optical cameras. In such digital still cameras, photographed images are stored as digital information into a memory or the like, and there is a demand for further more memory areas. Accordingly, for example, the number of products where not only a removable memory card but also a hard disk of large capacity is built in a digital still camera has increased. In general, however, a hard disk drive is vulnerable to impact, and for example, even a hard disk drive to be loaded in a notebook personal computer requires countermeasures against impact such as dropdown, vibration or the like.

Namely, in Patent Document 1 (Jpn. Pat. Appln. KOKAI Publication No. 2004-152116), a notebook personal computer has a spring piece for absorbing impact when attaching a hard disk drive to the main body thereof.

However, in the prior art of the Patent Document 1, a method of loading a hard disk drive to a notebook personal computer is disclosed, and a method of loading a hard disk drive or the like to a configuration particular to an image pickup device such as a digital still camera is not to be found, which has been a problem with the prior art.

### BRIEF SUMMARY OF THE INVENTION

An embodiment of the present invention is an image pickup device comprising: a first casing; a second casing constructed to be slidably engaged into the first casing; an image pickup unit arranged in the first casing or the second casing, the image pickup unit receiving reflected light from an object via a lens and outputting image information corresponding to the reflected light; a cushioning member constructed to be connected to the first casing and the second casing, respectively, and is expanded or contracted according to sliding action of the second casing; and a recording unit connected to the first casing and the second casing via the cushioning member, the recording unit recording the image information output from the image pickup unit to a storage area.

### BRIEF DESCRIPTION OF THE SEVERAL VIEWS OF THE DRAWING

FIG. 1 is an explanatory view showing an example of the structure of an image pickup device according to one embodiment of the invention;

FIG. 2 is an explanatory view showing another example of the structure of an image pickup device according to one embodiment of the invention;

FIG. 3 is an explanatory view showing still another example of the structure of an image pickup device according to one embodiment of the invention; and

FIG. 4 is a block diagram showing an example of the structure of an image pickup device according to one embodiment of the invention.

### DETAILED DESCRIPTION OF THE INVENTION

Embodiments of the present invention will be illustrated in more details with reference to the accompanying drawings hereinafter.

<Structure and Operation of Image Pickup Device According to the Invention>

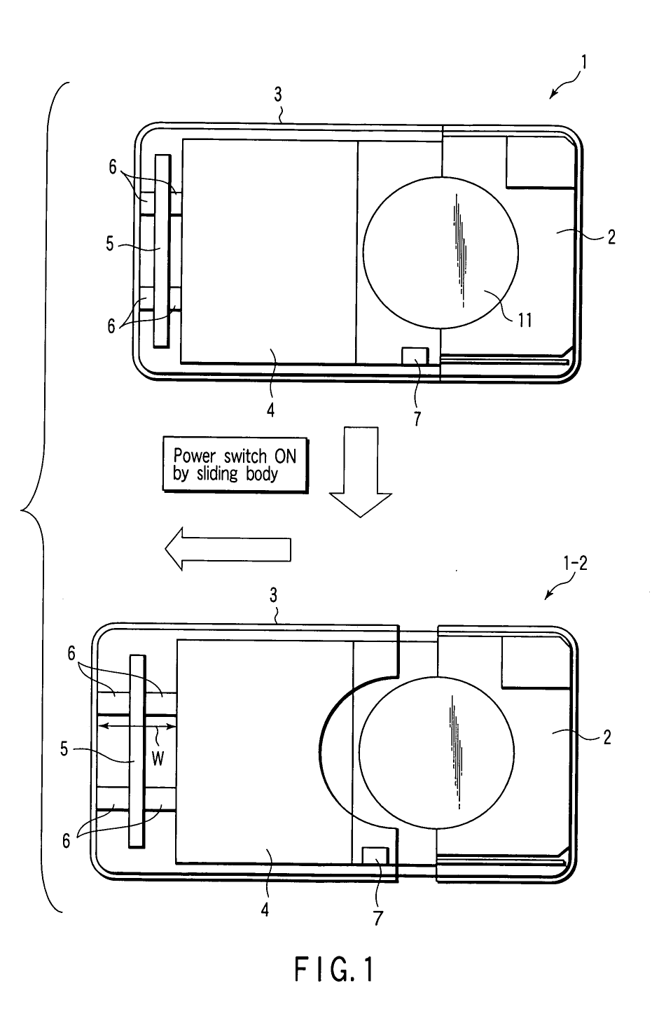

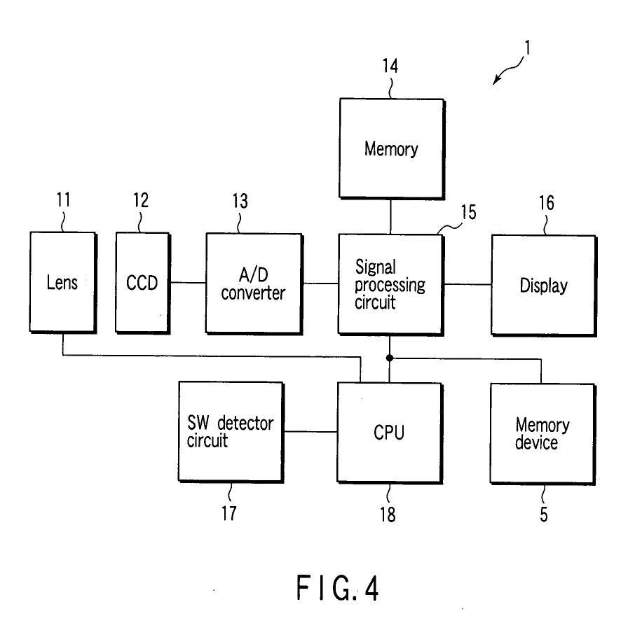

First, the structure and operation of an image pickup device (for example, a digital still camera (also available with a motion picture processing function)) according to the invention will be explained in details with reference to the accompanying drawings. An image pickup device 1 (digital still camera as one example) of the invention, as shown in FIGS. 1 to 4, has a lens 11, a CCD 12, an A/D converter 13, a signal processing circuit 15, and a memory 14. The lens 11 receives a photographed light from an object. The CCD 12 receives an image light that is focused by the lens 11. The A/D converter 13 receives an electric signal output from the CCD 12 according to the image light. The signal processing circuit 15 receives an output signal (image data) from the A/D converter 13 and carries out an image processing. The memory 14 temporarily stores image data after the image processing, and is attachable and detachable via an interface. The image pickup device 1 also has a CPU 18 connected to the respective units, for controlling the entire operation and further, it has: a storage device 5 such as, for example, a hard disk or a large size memory, for making image data stored in the memory 14 into image files and storing the files; and a display 16 such as a liquid crystal screen, for displaying images corresponding to the image files stored in the memory 14 and the storage device 5. The image pickup device operates under the control of the CPU 18, according to signals from a detector circuit 17 such as operation switches including a shutter and a mode switch, and an optical sensor.

Namely, the image pickup device 1 according to the invention carries out the following processing by the above configuration under the control of the CPU 18. That is, a photographed light from an object is received via the lens 11, image data output from the CCD 12 corresponding to the image focused by the lens 11 is converted by the A/D converter 13, the converted image data is appropriately subjected to an image processing at the signal processing circuit 15, and the image data is made into image files and stored into the memory 14 and the storage device 5. Further, according to operations, the image pickup device displays images corresponding to image files in the display 16 such as a liquid crystal screen.

<Cushioning Structure of Hard Disk Drive or the Like in Image Pickup Device According to the Invention>

Next, a cushioning structure such as a hard disk drive or the like in the image pickup device according to the invention will be explained in details with reference to FIGS. 1 to 3. Namely, in FIG. 1, an image pickup device 1 has a first casing 2 as a main body, a second casing 3 as a cover unit, and an electric unit 4 that is incorporated with the first casing 2. Herein, as shown in an image pickup device 1-2 at photographing, the cover unit 3 may be slid. At this moment, for example, it is preferred that a power switch 7 becomes ON, but, the power switch 7 is not always required for the embodiment of the invention.

What is to be noted herein is that the cover unit 3 is slid, whereby there occurs an empty space W in the inside of the cover unit 3. By use of the empty space W, it is possible to generate an empty space, for example, around the hard disk drive 5. In this manner, it becomes possible to remarkably improve the impact durability of the hard disk drive.

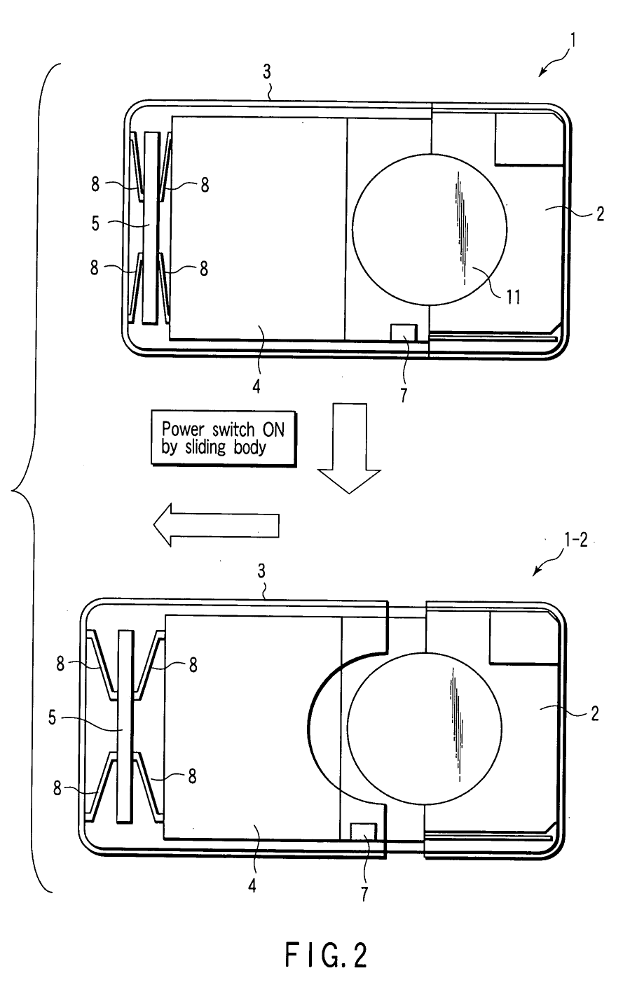

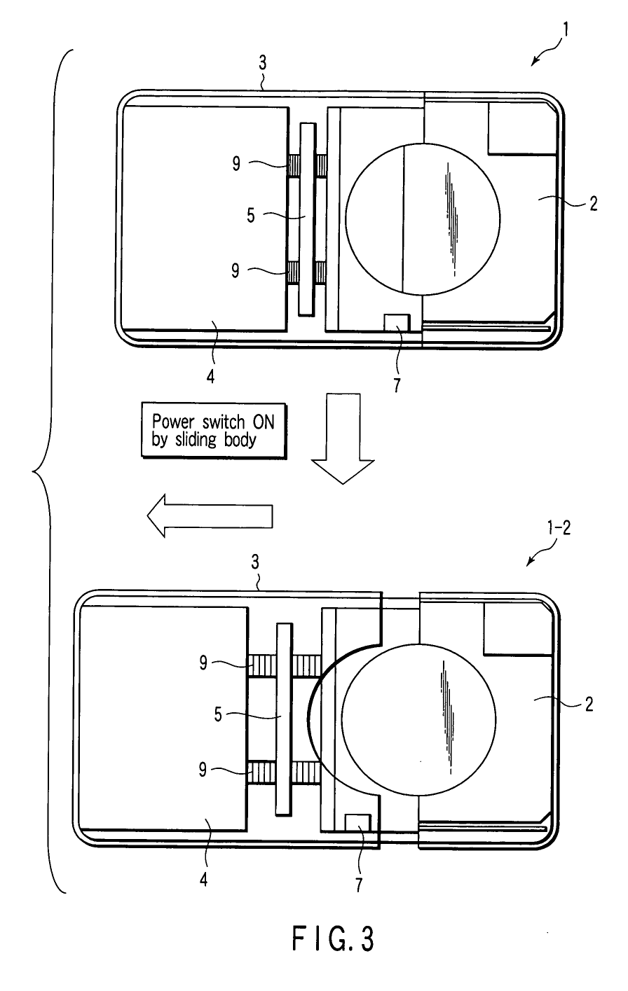

Herein, a cushioning member 6 must have expandability for expansion and contraction, according to sliding action of the cover unit 3. Accordingly, it is preferred that the cushioning member 6 is, for example, a rubber member, or a plastic member, or as shown in FIG. 2, a plate shaped spring member, or as shown in FIG. 3, an accordion shaped holding member, or a spiral spring. In these members, as the cover unit 3 is slid, the respective cushioning members 6, 8, and 9 expand and contract accordingly, and hold the hard disk drive 5. As shown in FIGS. 1 to 3, the cushioning members 6, 8, and 9 are basically arranged between the first casing 2 and the hard disk drive 5, and further arranged between the second casing 3 as a cover unit and the hard disk drive 5, and the hard disk drive 5 is not connected directly to the first casing 2 or the cover unit 3.

However, it is preferred to carry out electric wiring, for example, by arranging a flexible wire (not shown) between the hard disk drive 5 and the electric unit 4. In addition, even if there is a bit of mechanical connection with peripheral components, such a connection will not significantly lose the impact resistance of the invention, and therefore, a bit of connection may be provided.

Further, the image pickup device according to the invention is not limited to the above-mentioned cushioning member, but, as long as the hard disk drive 5 has expandability for expansion and contraction according to sliding action of the cover unit 3 in the same manner, the same effect can be attained.

As explained above, in the image pickup device according to the invention, the empty space to be used for absorbing impact is arranged in the inside of the image pickup device when the cover unit is slid at photographing, and as a consequence, it is possible to attain both the compact size of the casing during transportation (during non photographing) and the impact resistance during photographing.

As explained heretofore, the above-mentioned image pickup device comprises, for example, the first casing as a main body, and the second casing as a cover unit of the main body. The cover unit has a configuration of sliding, thereby, for example, the power switch is turned on, or the cover of an objective lens is removed and a lens is exposed. In such a configuration, when the cover unit is slid outward, an empty space is made in the inside of the cover unit. In the present invention, a hard disk drive is held just at the center of the empty space by a cushioning member of, for example, a rubber member, a plastic member, an accordion shaped holding member or the like.

At this moment, one cushioning member holds the hard disk drive and the first casing so as to freely expand and contract therebetween, and the other cushioning member holds the hard disk drive and the second casing (cover unit) so as to freely expand and contract therebetween. Accordingly, even when a user opens and closes the cover unit, the hard disk drive operates while being held between the hard disk drive and the second casing (cover unit).

Herein, what is to be noted is that when the cover unit is opened and set in its photographing condition, the space around the hard disk drive is wide. Therefore, the impact resistance is increasingly improved in comparison with the case where the cover unit is closed and set in its photographing standby condition. Accordingly, for example, even if the user drops a digital still camera by mistake during photographing, the possibility of direct destruction of the hard disk drive is extremely low. In this manner, the invention attains both the compact size of the casing during transportation and the impact resistance during photographing.

According to various embodiments described above, those skilled in the art can realize the present invention, and further can easily conceive various modifications from these embodiments, and the invention can be applied to various embodiments even without having innovative capabilities. Therefore, the invention includes a wide scope of forms without departing from the principle disclosed herein or novel characteristics thereof, and is not limited to the above-mentioned embodiments.

What is claimed is:

1. An image pickup device comprising:
a first casing;
a second casing constructed to be slidably engaged into the first casing;
an image pickup unit arranged in the first casing or the second casing, the image pickup unit receiving reflected light from an object via a lens and outputting image information corresponding to the reflected light;
a cushioning member constructed to be connected to the first casing and the second casing, respectively, and be expanded or contracted according to sliding action of the second casing; and
a recording unit connected to the first casing and the second casing via the cushioning member, the recording unit recording the image information output from the image pickup unit to a storage area.

2. An image pickup device according to claim 1, wherein the recording unit is held in space inside of the second casing constructed to be made when the second casing is slid, via the expanded cushioning member.

3. An image pickup device according to claim 1, wherein the recording unit is a hard disk drive constructed to be held via the cushioning member.

4. An image pickup device according to claim 1, wherein the cushioning member includes a rubber member.

5. An image pickup device according to claim 1, wherein the cushioning member includes a plastic member.

6. An image pickup device according to claim 1, wherein the cushioning member is an accordion shaped holding member.

7. An image pickup device according to claim 1, wherein the cushioning member includes a sponge member.

8. An image pickup device according to claim 1, wherein the cushioning member includes a plate shaped spring member.

9. An image pickup device according to claim 1, wherein the cushioning member includes a spiral spring member.

10. An image pickup device according to claim 1, further comprising a switch element arranged on the second casing, the switch element turning on the image pickup device when the second casing is slid.
